(19) United States
(12) Patent Application Publication
(10) Pub. No.: US 2026/0115971 A1
(43) Pub. Date: Apr. 30, 2026

(54) METHOD OF RECYCLING REINFORCED RESIN

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Dae Sung Jung, Hwaseong-si (KR); Jaehoon Kim, Seongnam-si (KR); Jae Ryeong Jeong, Suwon-si (KR); Aye Aye Myint, Suwon-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/295,207

(22) Filed: Aug. 8, 2025

(30) Foreign Application Priority Data
Oct. 31, 2024 (KR) 10-2024-0152322

(51) Int. Cl. B29B 17/02; B29K 77/00; B29K 309/08

(52) U.S. Cl. CPC B29B 17/02; B29B 2017/0293; B29K 2077/00; B29K 2309/08

(57) ABSTRACT

A method of recycling a reinforced resin including glass fiber and the like includes: obtaining a solution by adding a composite material including a polyamide and a reinforcing agent to a solvent, and dissolving the polyamide in the solvent. The method further includes obtaining an intermediate material by filtering the reinforcing agent from the solution, precipitating the polyamide by adding an antisolvent to the intermediate material, and recovering the precipitated polyamide.

### CROSS-REFERENCE TO RELATED APPLICATION

This application claims, under 35 U.S.C. § 119(a), priority to Korean Patent Application No. 10-2024-0152322, filed on Oct. 31, 2024, the entire contents of which are incorporated herein by reference.

### FIELD

The present disclosure relates to a method of recycling a reinforced resin including glass fiber and the like.

### BACKGROUND

Global original equipment manufacturers (OEMs) are intensifying research on recycling steel, aluminum, and plastics to achieve carbon neutrality and circular economy goals. In particular, a draft European scrappage regulation, due in the second half of 2023, is considering capping the recycled plastic content at 25%.

In glass fiber reinforced composites, the length and tensile strength of glass fiber decrease each additional time processing is performed. When processing is performed five times, the length of glass fiber is reduced by 50% and the tensile strength is reduced by 30%. During the processes of crushing, extrusion, and injection, the length of glass fiber decreases, which deteriorates mechanical properties, and variations in the length of glass fiber cause scattering in properties, resulting in failure to satisfy the properties required for vehicle plastics.

In order to respond to carbon neutrality and regulations on the use of recycled plastics, the development of chemical recycling techniques such as solvent extraction and pyrolysis is essential as complementary techniques to mechanical recycling.

The relevant materials include carpets and carpet tiles containing nylon. The dissolution temperature of nylon during solvent extraction is in a range of 135° C. to 155° C. The energy cost required to increase the solvent temperature during this process is excessive and the volatility of the solvent at high temperatures may pose a safety risk to workers. In addition, the dissolution pressure of nylon during solvent extraction ranges from 207×10⁴ Pa to 345×10⁴ Pa, which causes excessive energy costs to be incurred in increasing the solvent pressure, and process control is difficult under high pressure, which is undesirable.

### SUMMARY

Various aspects are to provide a method of recycling a reinforced resin having high recovery efficiency of a polyamide.

Various aspects are to provide a method of recycling a reinforced resin capable of recovering polyamide at room temperature under atmospheric pressure.

Various aspects are not limited to the foregoing. Various aspects should be clearly understood through the following description and to be realized by the means described in the claims and combinations thereof.

Various aspects may provide a method of recycling a reinforced resin, including obtaining a solution by adding a composite material including a polyamide and a reinforcing agent to a solvent and dissolving the polyamide in the solvent, obtaining an intermediate material by filtering the reinforcing agent from the solution, precipitating the polyamide by adding an antisolvent to the intermediate material, and recovering the precipitated polyamide.

The polyamide may include one or more of Polyamide 6 (PA6) and Polyamide 66 (PA66).

The reinforcing agent may include glass fiber.

The composite material may include a range of 60 wt % to 80 wt % of the polyamide and a range of 20 wt % to 40 wt % of the reinforcing agent.

The solvent may include one or more of formic acid, benzyl alcohol, dimethyl sulfoxide (DMSO) and acetic acid.

The solvent may include formic acid, and obtaining the solution may include dissolving the polyamide in the solvent in a range of 20° C. to 25° C.

The concentration of formic acid may be 85 wt % or more.

The solvent may include benzyl alcohol, and obtaining the solution may include dissolving the polyamide in the solvent in a range of 150° C. to 170° C.

The solvent may include dimethyl sulfoxide, and obtaining the solution may include dissolving the polyamide in the solvent in a range of 115° C. to 135° C.

The solvent may include acetic acid, and obtaining the solution may include dissolving the polyamide in the solvent in a range of 110° C. to 130° C.

The composite material may be added to the solvent so that a content of the composite material is in a range of 10 w/v % to 20 w/v %.

Obtaining the solution may include dissolving the polyamide in the solvent for 1 hour or more.

The antisolvent may include methanol, ethanol, propanol, isopropanol, butanol, pentanol, hexanol, or any combinations thereof.

Precipitating the polyamide may include adding the antisolvent to change a solubility of the polyamide of the intermediate material, thereby precipitating the polyamide.

In the recycling method, the recovery efficiency of polyamide may be 90% or more.

### BRIEF DESCRIPTION OF THE DRAWINGS

The above and other features of the present disclosure will now be described in detail with reference to certain various aspects illustrated in the accompanying drawings which are given hereinbelow by way of illustration only, and thus are not limitative of the present disclosure.

FIG. 1 shows a process of recycling a reinforced resin according to the present disclosure.

FIG. 2 shows results of Fourier transform infrared spectroscopy (FT-IR) of Polyamide 6 recovered in Test Example 7.

FIG. 3 shows results of measurement of the melting point of Polyamide 6 recovered in Test Example 7.

FIG. 4 shows results of measurement of the crystallization temperature of Polyamide 6 recovered in Test Example 7.

FIG. 5 shows results of Fourier transform infrared spectroscopy (FT-IR) of Polyamide 66 recovered in Test Example 8.

FIG. 6 shows results of measurement of the melting point of Polyamide 66 recovered in Test Example 8.

FIG. 7 shows results of measurement of the crystallization temperature of Polyamide 66 recovered in Test Example 8.

FIG. 8 shows results of high-performance liquid chromatography of Polyamide 6 recovered in Test Example 9.

FIG. 9 shows results of thermogravimetric analysis (TGA) of Polyamide 6 recovered in Test Example 9.

FIG. 10 shows results of derivative thermogravimetric analysis (DTG) of Polyamide 6 recovered in Test Example 9.

FIG. 11 shows results of high-performance liquid chromatography of Polyamide 66 recovered in Test Example 10.

FIG. 12 shows results of thermogravimetric analysis (TGA) of Polyamide 66 recovered in Test Example 10.

FIG. 13 shows results of derivative thermogravimetric analysis (DTG) of Polyamide 66 recovered in Test Example 10.

### DETAILED DESCRIPTION

The above and other aspects, features and advantages of the present disclosure are more clearly understood from the following various aspects taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals will refer to the same or like elements. For the sake of clarity of the present disclosure, the dimensions of structures may be depicted as being larger than the actual sizes thereof.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

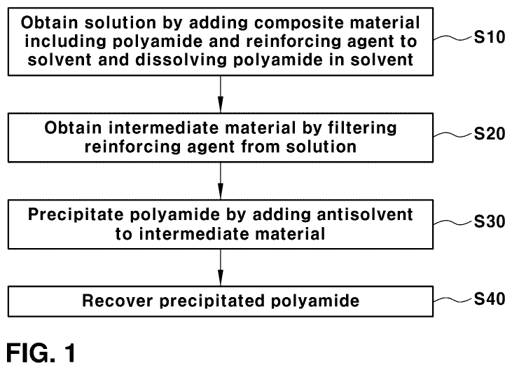

FIG. 1 shows a process of recycling a reinforced resin according to the present disclosure. The method of recycling the reinforced resin may include obtaining a solution by adding a composite material including a polyamide and a reinforcing agent to a solvent and dissolving the polyamide in the solvent (S10), obtaining an intermediate material by filtering the reinforcing agent from the solution (S20), precipitating the polyamide by adding an antisolvent to the intermediate material (S30), and recovering the precipitated polyamide (S40).

The composite material may be collected from interior and exterior materials of automobiles. For example, the composite material may be collected from interior trim such as a dashboard, door panel, center console, and the like; carpets or mats; seats; stoppers or rubber parts responsible for sealing or fixing; and the like.

The composite material may include a fiber-reinforced resin. For example, the composite material may include polyamide reinforced with a reinforcing agent such as glass fiber, and the like.

The polyamide may include Polyamide 6 (PA6), Polyamide 66 (PA66), or any combinations thereof. Polyamide 6 is a polymer of caprolactam, and Polyamide 66 is a polymer of hexamethylenediamine and adipic acid. Polyamide 6 and Polyamide 66 have excellent mechanical properties such as tensile strength, durability, and the like, heat resistance, and chemical resistance.

The reinforcing agent may include glass fiber, carbon fiber, basalt fiber, natural fiber, and the like, and the reinforcing agent includes glass fiber. The basalt fiber is a fiber extracted from volcanic rock and has high heat and chemical resistance and similar properties to glass fiber. The natural fiber may include fiber such as hemp, linen, cotton, and the like.

The composite material may include 60 wt % to 80 wt % of the polyamide and 20 wt % to 40 wt % of the reinforcing agent. If the content of the reinforcing agent exceeds 40 wt %, the relative content of polyamide that may be recovered may decrease, which may lower the efficiency of the recycling method.

The solvent may be one that dissolves polyamide but does not dissolve the reinforcing agent. To this end, the solvent may be selected based on the Hansen solubility parameters, boiling points, and the like.

To determine solubility or miscibility of materials, similarities between the materials have to be compared using the intrinsic properties thereof. There are several intrinsic properties that affect solubility or miscibility, and in particular, the solubility parameter, which quantitatively represents the extent of interaction in a material, is the most widely used. Each material has its own unique solubility parameter, and materials with similar solubility parameter values dissolve or mix well with each other.

Although solubility parameters based on various theories or concepts have been proposed and used, solubility characteristics are most accurately represented by the Hansen solubility parameters (HSP) proposed by Dr. C. Hansen in 1967. The Hansen solubility parameter divides the extent of interaction in a material into the following three factors.

Dispersion force (δ_{D}): Nonpolar interaction that occurs in all molecules, mainly corresponding to van der Waals force.

Polar force (δ_{P}): Dipolar interaction between polar molecules, the force with which polar molecules attract each other. The extent of polarity of a material is considered.

Hydrogen bonding (δ_{H}): Interaction by hydrogen bonding. It evaluates how strongly a material with high hydrogen bonding capability binds to another material.

The Hansen solubility parameter is a vector that has magnitude and direction in a space composed of three elements, and the basic unit representing the same is (MPa)^{1/2}. Each vector value of the Hansen solubility parameters may be calculated using a program called HSPiP (Hansen Solubility Parameters in Practice) developed by Dr. C. Hansen's group.

The total solubility parameter (δ_{T}) of a material may be calculated using the following equation.

$${δ}_{{T}^{2}} [ {MPa}^{1 / 2} ] = {δ}_{{D}^{2}} + {δ}_{{P}^{2}} + {δ}_{{H}^{2}}$$

If the vector values of the Hansen solubility parameters of two materials are similar, these materials dissolve well in each other. However, since the Hansen solubility parameter is a vector, in order to determine that the materials are similar, the magnitudes of all three vectors of each material must be similar. This may be represented as the Hansen solubility parameter difference (Rₐ) between the two materials. The smaller the Hansen solubility parameter difference (Rₐ), the better the solubility and miscibility.

$${( {R}_{a} )}^{2} = 4 {( {δ}_{{D}^{solvent}} - {δ}_{{D}^{polymer}} )}^{2} + {( {δ}_{{P}^{solvent}} - {δ}_{{P}^{polymer}} )}^{2} + {( {δ}_{{H}^{solvent}} - {δ}_{{H}^{polymer}} )}^{2}$$

Each material has a radius parameter (R₀) that represents the radius of interaction in the solubility region in the Hansen solubility parameters. The radius parameter defines the range within which a certain material may dissolve with other materials. This makes it possible to determine how soluble a given material is in a certain solvent.

When using the Hansen solubility sphere, the radius parameter indicates the radius of a sphere, and all materials in this sphere may be considered to have a high probability of dissolving in each other. The center of the sphere is defined by the Hansen solubility parameters (δ_{D}, δ_{P}, δ_{H}) of a certain material, and the radius of the sphere determines the range over which the material may be dissolved. Therefore, to actually evaluate whether two materials mix well, the Hansen solubility parameter difference (Rₐ) between the two materials must be smaller than the radius parameter (R₀).

The radius parameter of Polyamide 6 is about 5.78 MPa^{1/2}, and the radius parameter of Polyamide 66 is about 5.10 MPa^{1/2}.

However, in order to determine whether the corresponding material is dissolved in a certain solvent, not only the Hansen solubility parameters, but also the dissolution conditions, such as the boiling point of the solvent, temperature, stirring rate, concentration of the material, and the like, are regarded as very important.

In an embodiment of the present disclosure, examples of the solvent capable of selectively dissolving the polyamide in consideration of the Hansen solubility parameters, boiling point of the solvent, dissolution temperature, and the like, are shown in Table 1 below.

TABLE 1

| | Hansen | | |
|---|---|---|---|
| | solubility | | |
| | parameter | Boiling | |
| | difference | point | |
| Solvent | (Rₐ, MPa^{1/2}) | [° C.] | Results |
| Formic acid | 8.1 | 100.8 | PA6 and PA66 are |
| | | | dissolved at room |
| | | | temperature |
| Benzyl alcohol | 4.2 | 205.3 | PA6 and PA66 are |
| | | | dissolved at about 160° C. |
| Dimethyl | 7.3 | 189.0 | PA6 and PA66 are |
| sulfoxide | | | dissolved at about 125° C. |
| Acetic acid | 6.2 | 118.0 | PA6 and PA66 are |
| | | | dissolved at about 120° C. |
| Ethyl lactate | 3.5 | 155.0 | PA6 and PA66 are not |
| | | | dissolved even when |
| | | | heated to boiling point |
| Dimethylformamide | 4.2 | 153.0 | PA6 and PA66 are not |
| | | | dissolved even when |
| | | | heated to boiling point |
| Ethylene glycol | 3.1 | 150.0 | PA6 and PA66 are not |
| monopropyl ether | | | dissolved even when |
| | | | heated to boiling point |
| Ethylene glycol | 3.4 | 135.0 | PA6 and PA66 are not |
| monoethyl ether | | | dissolved even when |
| | | | heated to boiling point |
| Ethylene glycol | 5.0 | 125.0 | PA6 and PA66 are not |
| | | | dissolved even when |
| monomethyl ether | | | heated to boiling point |
| Acetic anhydride | 8.1 | 139.8 | PA6 and PA66 are not |
| | | | dissolved even when |
| | | | heated to boiling point |

The Hansen solubility parameter difference in Table 1 is a difference value in Hansen solubility parameters between each solvent and Polyamide 6.

Referring to Table 1, the solvent may include formic acid, benzyl alcohol, dimethyl sulfoxide (DMSO), acetic acid, or any combinations thereof. The solvent may include formic acid that enables dissolution at room temperature.

The solvent may include formic acid, and obtaining the solution (S10) may include dissolving the polyamide in the solvent in a range of 20° C. to 25° C. The concentration of formic acid may be 85 wt % or more. If the concentration of formic acid is less than 85 wt %, the polyamide may not be sufficiently dissolved.

The solvent may include benzyl alcohol, and obtaining the solution (S10) may include dissolving the polyamide in the solvent in a range of 150° C. to 170° C.

The solvent may include dimethyl sulfoxide, and obtaining the solution (S10) may include dissolving the polyamide in the solvent in a range of 115° C. to 135° C.

The solvent may include acetic acid, and obtaining the solution (S10) may include dissolving the polyamide in the solvent in a range of 110° C. to 130° C.

The polyamide may be dissolved by adding the same to the solvent followed by stirring. The stirring rate is not particularly limited and may be, for example, in a range of 200 rpm to 400 rpm.

The composite material may be added to the solvent so that the content of the composite material is in a range of 10 w/v % to 20 w/v %. If the content of the composite material exceeds 20 w/v %, it may be difficult to dissolve the polyamide in the solvent because the concentration of the solution is too high to allow stirring.

Obtaining the solution (S10) may include dissolving the polyamide in the solvent for 1 hour or more. The upper limit of the dissolution time is not particularly limited, and may be 48 hours or less, 36 hours or less, or 24 hours or less. If the dissolution time of polyamide is less than 1 hour, the polyamide may not be sufficiently dissolved in the solvent.

The solution may include the solvent, the polyamide dissolved in the solvent, and the reinforcing agent not dissolved in the solvent.

An intermediate material may be obtained by filtering and separating the reinforcing agent from the solution (S20). The intermediate material may include the solvent and the polyamide dissolved in the solvent.

A process of filtering the reinforcing agent is not particularly limited, and the reinforcing agent may be filtered and separated by a process such as gravity filtration, vacuum filtration, microfiltration, and the like. The filtered reinforcing agent may be dried and reused. The drying conditions of the reinforcing agent are not particularly limited, and for example, the reinforcing agent may be dried at about 60° C. to 80° C. for about 24 to 48 hours.

An antisolvent may be added to the intermediate material, so the solubility of the polyamide of the intermediate material may be changed, thereby precipitating the polyamide (S30).

The antisolvent may be used to decrease the solubility of a material in a certain solvent or to promote precipitation of the material. When the antisolvent is added to the intermediate material, the solubility of the polyamide may decrease and the polyamide may be deposited and precipitated in a non-dissolved state. Therefore, the polyamide may be easily recovered.

The solvent and the antisolvent have to be separated from each other after recovering the precipitated polyamide, and it is desirable to use an antisolvent having a large boiling point difference from the solvent. The antisolvent may include methanol, ethanol, propanol, isopropanol, butanol, pentanol, hexanol, or any combinations thereof, and the antisolvent includes methanol.

The precipitated polyamide may be recovered by a process such as filtration, and the like (S40). The process of recovering the polyamide is not particularly limited, and filtration and separation may be performed by a process such as gravity filtration, vacuum filtration, microfiltration, and the like. The filtered polyamide may be dried and reused. The drying conditions of the polyamide are not particularly limited, and for example, the polyamide may be dried at about 60° C. to 80° C. for about 24 to 48 hours.

The method of recycling the reinforced resin may have reinforcing agent recovery efficiency of 90% or more and polyamide recovery efficiency of 90% or more. The recovery efficiency may be obtained by expressing a ratio of the mass of each component in the composite material and the mass of each component recovered as a percentage.

A better understanding of the present disclosure may be obtained through the following examples. These examples are merely set forth to illustrate the present disclosure, and are not to be construed as limiting the scope of the present disclosure.

### Test Example 1

A solution was obtained by adding a composite material including 30.5 wt % of glass fiber and 69.5 wt % of Polyamide 6 to formic acid and dissolving Polyamide 6 in formic acid. The composite material was added so that the content thereof was about 20 w/v %. The concentration of formic acid used was 85 wt %. At about 25° C., the dissolution time was changed as shown in Table 2 below.

An intermediate material was obtained by filtering the glass fiber from the solution. The filtered glass fiber was dried at about 70° C. for about 24 hours. The glass fiber recovery efficiency is shown in Table 2 below.

Methanol was added to the intermediate material to precipitate Polyamide 6, and then the precipitated Polyamide 6 was recovered. The recovered Polyamide 6 was dried at about 70° C. for about 24 hours. The recovery efficiency of Polyamide 6 is shown in Table 2 below.

### Test Example 2

Glass fiber and Polyamide 66 were recovered in the same manner as in Test Example 1, with the exception that a composite material including 31.5 wt % of glass fiber and 68.5 wt % of Polyamide 66 was used, and the recovery efficiency of each component is shown in Table 2 below.

TABLE 2

| | | | | Glass fiber | Polyamide |
|---|---|---|---|---|---|
| | Composite | | | recovery | recovery |
| | material | Dissolution | | efficiency | efficiency |
| Classification | content | time | | [%] | [%] |
| Test | 20 w/v % | 30 | min | 99 | 86.5 |
| Example 1 | | 1 | hr | 99 | 96.0 |
| | | 2 | hr | 99 | 95.3 |
| Test | 20 w/v % | 30 | min | 99 | 90.0 |
| Example 2 | | 1 | hr | 99 | 93.7 |
| | | 2 | hr | 99 | 95.9 |

Referring to Table 2, the polyamide recovery efficiency was very low when the dissolution time was less than 1 hour. Therefore, the recovery efficiency can be found to increase when the dissolution time for polyamide is 1 hour or more.

### Test Example 3

A solution was obtained by adding a composite material including 30.5 wt % of glass fiber and 69.5 wt % of Polyamide 6 to formic acid and dissolving Polyamide 6 in formic acid. The content of the composite material was adjusted to about 10 w/v % and 20 w/v %. The concentration of formic acid used was 85 wt %. The dissolution time was about 1 hour, and different dissolution temperatures of about 25° C. and 40° C. were applied.

An intermediate material was obtained by filtering the glass fiber from the solution. The filtered glass fiber was dried at about 70° C. for about 24 hours. The glass fiber recovery efficiency is shown in Table 3 below.

Methanol was added to the intermediate material to precipitate Polyamide 6, and then the precipitated Polyamide 6 was recovered. The recovered Polyamide 6 was dried at about 70° C. for about 24 hours. The recovery efficiency of Polyamide 6 is shown in Table 3 below.

### Test Example 4

Glass fiber and Polyamide 66 were recovered in the same manner as in Test Example 3, with the exception that a composite material including 31.5 wt % of glass fiber and 68.5 wt % of Polyamide 66 was used, and the recovery efficiency of each component is shown in Table 3 below.

TABLE 3

| | | | | Glass | |
|---|---|---|---|---|---|
| | | | | fiber | Polyamide |
| | | | Composite | recovery | recovery |
| | Dissolution | Dissolution | material | efficiency | efficiency |
| Classification | time | temperature | content | [%] | [%] |
| Test | 1 hr | 25° C. | 10 w/v % | 99 | 96.89 |
| Example 3 | | | 20 w/v % | 99 | 96.02 |
| | | 40° C. | 20 w/v % | 99 | 93.60 |
| Test | 1 hr | 25° C. | 10 w/v % | 98.4 | 96.64 |
| Example 4 | | | 20 w/v % | 99 | 93.72 |
| | | 40° C. | 20 w/v % | 99.5 | 99.3 |

Referring to Table 3, the polyamide recovery efficiencies depending on the dissolution temperature were similar under all conditions. However, the recovery efficiency of Polyamide 6 was higher at a dissolution temperature of 25° C. than at 40° C.

### Test Example 5

A solution was obtained by adding a composite material including 30.5 wt % of glass fiber and 69.5 wt % of Polyamide 6 to formic acid and dissolving Polyamide 6 in formic acid. The content of the composite material was adjusted to about 10 w/v % and 20 w/v %. The concentrations of formic acid used were 85 wt % and 98 wt %. Dissolution was performed for about 1 hour at about 25° C.

An intermediate material was obtained by filtering the glass fiber from the solution. The filtered glass fiber was dried at about 70° C. for about 24 hours. The glass fiber recovery efficiency is shown in Table 4 below.

Methanol was added to the intermediate material to precipitate Polyamide 6, and then the precipitated Polyamide 6 was recovered. The recovered Polyamide 6 was dried at about 70° C. for about 24 hours. The recovery efficiency of Polyamide 6 is shown in Table 4 below.

### Test Example 6

Glass fiber and Polyamide 66 were recovered in the same manner as in Test Example 5, with the exception that a composite material including 31.5 wt % of glass fiber and 68.5 wt % of Polyamide 66 was used, and the recovery efficiency of each component is shown in Table 4 below.

TABLE 4

| | | | | Glass | |
|---|---|---|---|---|---|
| | | | | fiber | Polyamide |
| | | | Composite | recovery | recovery |
| | Dissolution | Formic acid | material | efficiency | efficiency |
| Classification | time | concentration | content | [%] | [%] |
| Test | 1 hr | 98 wt % | 10 w/v % | 99 | 96.89 |
| Example 5 | | | 20 w/v % | 99 | 96.02 |
| | | 85 wt % | 20 w/v % | 99 | 92.7 |
| Test | 1 hr | 98 wt % | 10 w/v % | 98.4 | 96.64 |
| Example 6 | | | 20 w/v % | 99 | 93.72 |
| | | 85 wt % | 20 w/v % | 99 | 96.2 |

Referring to Table 4, when the concentration of formic acid was 85 wt % or higher, the polyamide recovery efficiencies were determined to be similar under all conditions.

### Test Example 7

A solution was obtained by adding a composite material including 30.5 wt % of glass fiber and 69.5 wt % of Polyamide 6 to formic acid and dissolving Polyamide 6 in formic acid. The content of the composite material was about 20 wt %, the concentration of formic acid was 85 wt %, and Polyamide 6 was dissolved under the conditions of 1 hour and 25° C.

An intermediate material was obtained by filtering the glass fiber from the solution. The filtered glass fiber was dried at about 70° C. for about 24 hours. The glass fiber recovery efficiency is shown in Table 5 below.

Each of methanol, water, and acetone was added as an antisolvent to the intermediate material to precipitate Polyamide 6, and then the precipitated Polyamide 6 was recovered. The recovered Polyamide 6 was dried at about 70° C. for about 24 hours. The recovery efficiency of Polyamide 6 is shown in Table 5 below.

The thermal properties of recovered Polyamide 6 were measured by thermogravimetric analysis (TGA). The results thereof are shown in Table 5 below.

TABLE 5

| | Recovery | | | | | | |
|---|---|---|---|---|---|---|---|
| | efficiency | | | | | | |
| | [%] | | Thermal properties | | | | |
| | | Glass | Melting | Enthalpy | Crystallization | Enthalpy of | Crystallinity |
| Classification | PA6 | fiber | point | of melting | temperature | crystallization | [%] |
| Virgin PA6 | — | — | 221.5 | 56.2 | 167.4 | −63.5 | 27.2 |
| Composite | — | — | 212.5 | 53.6 | 182.1 | −46.8 | 25.9 |
| material | | | | | | | |
| PA6 | 99 | 99 | 221.1 | 157.3 | 189.0 | −68.4 | 37.1 |
| recovered | | | | | | | |
| with | | | | | | | |
| methanol | | | | | | | |
| PA6 | 97.0 | 90.3 | 220.8 | 66.2 | 187.6 | −71.9 | 38.5 |
| recovered | | | | | | | |
| with water | | | | | | | |
| PA6 | Not | Not | 222.3 | 103.6 | 186.9 | −76.9 | 35.9 |
| recovered | measured | measured | | | | | |
| with | | | | | | | |
| acetone | | | | | | | |

In Table 5, enthalpy of melting (AHm) is the energy required to change from a solid to a liquid, and the unit is mJ/mg. Crystallization temperature is the temperature at which a material begins to form a crystal structure as it changes from a liquid to a solid. Enthalpy of crystallization is a value representing the heat energy released or absorbed when a material is converted from a liquid or amorphous state to a crystalline state, and the unit is mJ/mg.

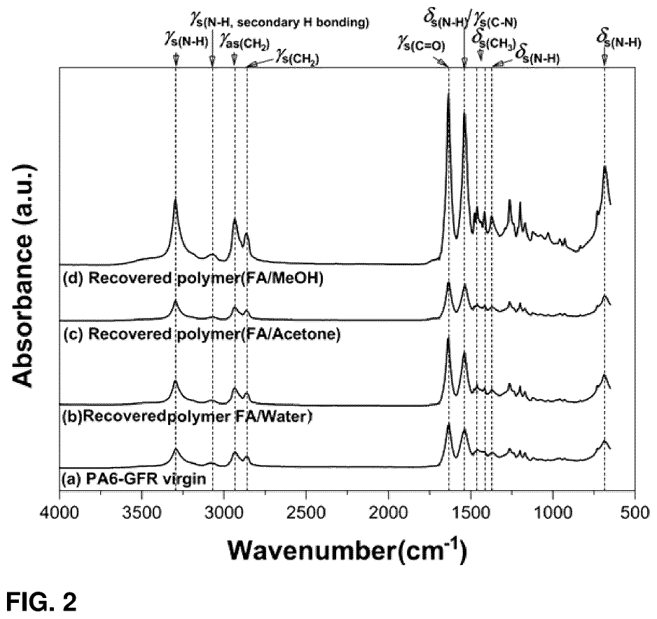

FIG. 2 shows results of Fourier transform infrared spectroscopy (FT-IR) of Polyamide 6 recovered in Test Example 7. Referring thereto, there was no difference in the material itself before and after recovery.

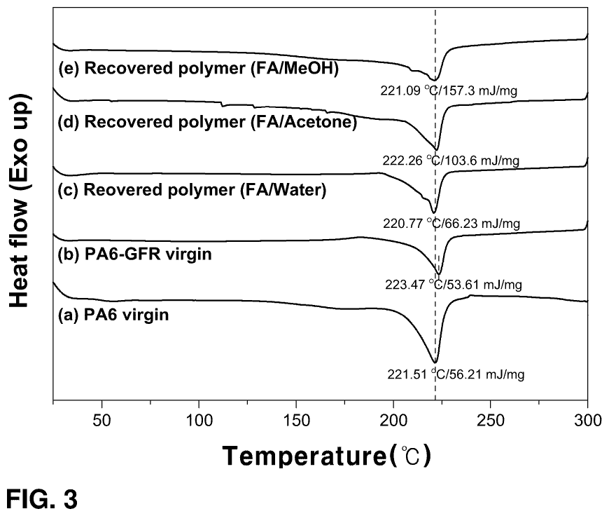

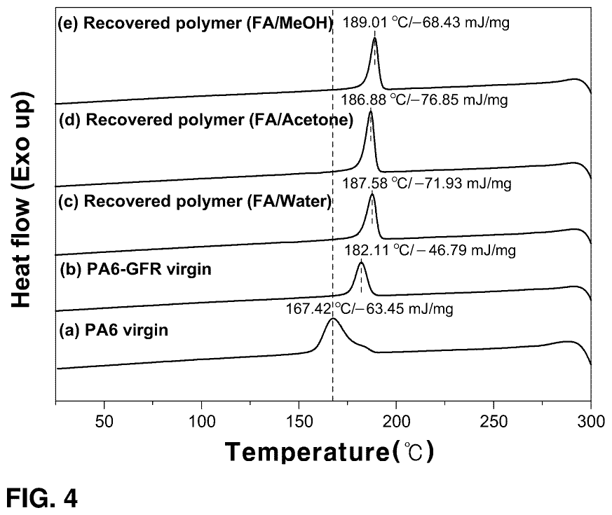

FIG. 3 shows results of measurement of the melting point of Polyamide 6 recovered in Test Example 7. FIG. 4 shows results of measurement of the crystallization temperature of Polyamide 6 recovered in Test Example 7. Based on the above results along with the results of Table 5, there was no difference in the material itself before and after recovery. However, when Polyamide 6 was precipitated in water or acetone, the recovery efficiency thereof was low or was not measured. Hence, it is advantageous to use methanol as the antisolvent.

### Test Example 8

A solution was obtained by adding a composite material including 31.5 wt % of glass fiber and 68.5 wt % of Polyamide 66 to formic acid and dissolving Polyamide 66 in formic acid. The content of the composite material was about 20 wt %, the concentration of formic acid was 85 wt %, and Polyamide 66 was dissolved under the conditions of 1 hour and 25° C.

An intermediate material was obtained by filtering the glass fiber from the solution. The filtered glass fiber was dried at about 70° C. for about 24 hours. The glass fiber recovery efficiency is shown in Table 6 below.

Each of methanol and water was added as an antisolvent to the intermediate material to precipitate Polyamide 66, and then the precipitated Polyamide 66 was recovered. The recovered Polyamide 66 was dried at about 70° C. for about 24 hours. The recovery efficiency of Polyamide 66 is shown in Table 6 below.

The thermal properties of recovered Polyamide 66 were measured by thermogravimetric analysis (TGA). The results thereof are shown in Table 6 below.

TABLE 6

| | Recovery | | | | | | |
|---|---|---|---|---|---|---|---|
| | efficiency | | | | | | |
| | [%] | | Thermal properties | | | | |
| | | Glass | Melting | Enthalpy | Crystallization | Enthalpy of | Crystallinity |
| Classification | PA66 | fiber | point | of melting | temperature | crystallization | [%] |
| Virgin PA66 | — | — | 264.4 | 47.2 | 230.6 | −43.0 | 29.8 |
| Composite | — | — | 264.2 | 67.2 | 219.5 | −60.4 | 20.9 |
| material | | | | | | | |
| PA66 | 90.0 | 99 | 264.6 | 86.9 | 234.2 | −60.6 | 38.5 |
| recovered | 3 | | | | | | |
| with | | | | | | | |
| methanol | | | | | | | |
| PA66 | NM | NM | 263.8 | 70.7 | 233.7 | −59.3 | 31.3 |
| recovered | | | | | | | |
| with water | | | | | | | |

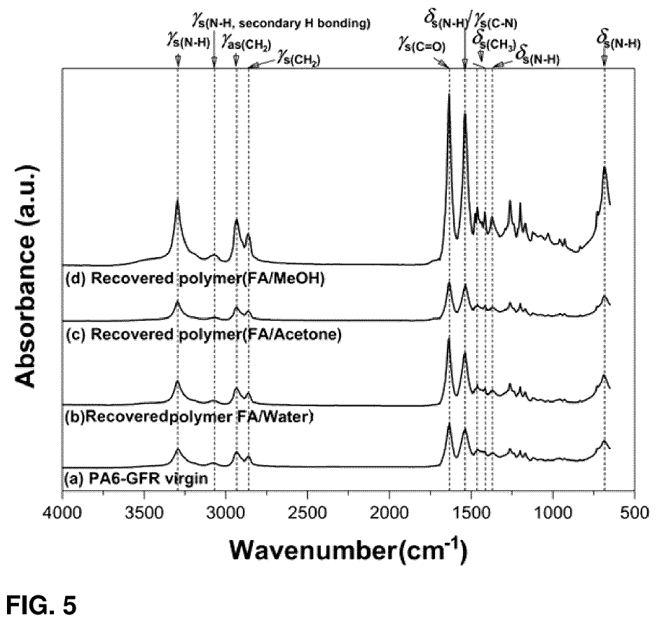

FIG. 5 shows results of Fourier transform infrared spectroscopy (FT-IR) of Polyamide 66 recovered in Test Example 8. Referring thereto, there was no difference in the material itself before and after recovery.

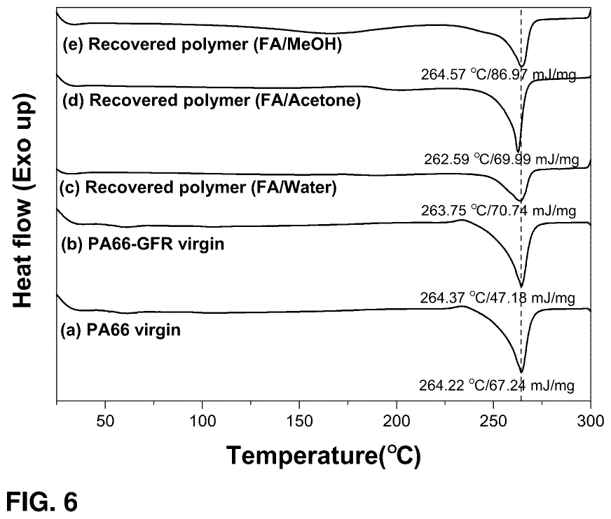

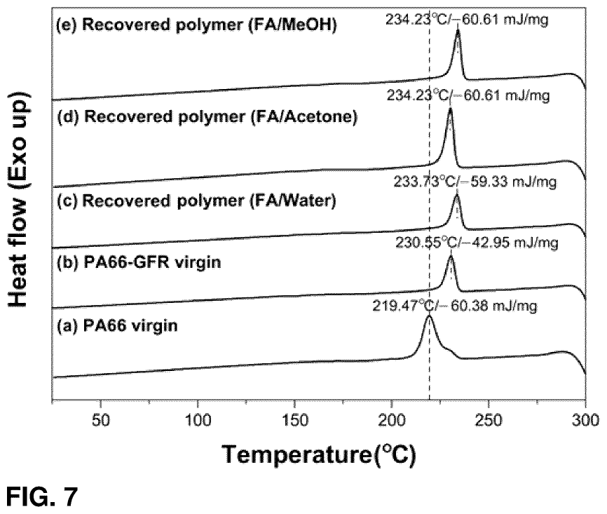

FIG. 6 shows results of measurement of the melting point of Polyamide 66 recovered in Test Example 8. FIG. 7 shows results of measurement of the crystallization temperature of Polyamide 66 recovered in Test Example 8. Based on the above results along with the results of Table 6, there was no difference in the material itself before and after recovery. However, when Polyamide 66 was precipitated in water, the recovery efficiency thereof was not measured. Hence, it is advantageous to use methanol as the antisolvent.

### Test Example 9

A solution was obtained by adding a composite material including 30.5 wt % of glass fiber and 69.5 wt % of Polyamide 6 to formic acid and dissolving Polyamide 6 in formic acid. The content of the composite material was adjusted to about 10 w/v % and 20 w/v %. The concentration of formic acid was 85 wt %, and Polyamide 6 was dissolved at 25° C. with stirring at about 300 rpm for 1 hour.

An intermediate material was obtained by filtering the glass fiber from the solution.

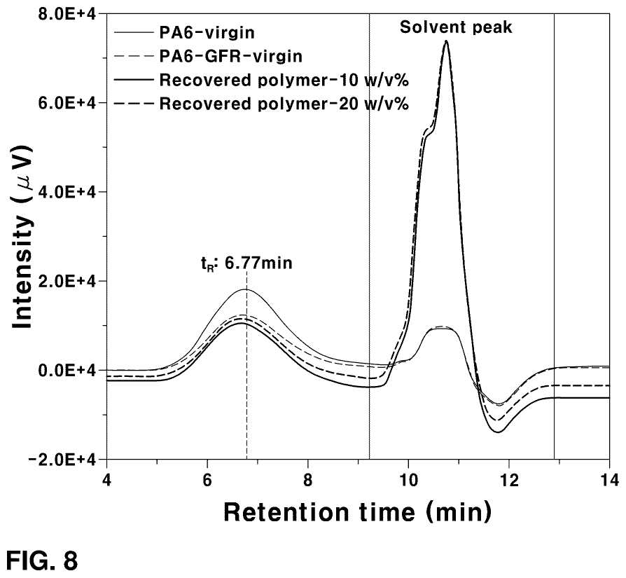

Methanol was added as an antisolvent to the intermediate material to precipitate Polyamide 6, and then the precipitated Polyamide 6 was recovered. The recovered Polyamide 6 was dried at about 70° C. for about 24 hours. FIG. 8 shows results of high-performance liquid chromatography analysis of Polyamide 6 recovered in Test Example 9. The molecular weight and polydispersity index (PDI) of Polyamide 6 were measured, and the results thereof are shown in Table 7 below.

TABLE 7

| | Number average | Weight average | |
|---|---|---|---|
| | molecular | molecular | |
| | weight | weight | Polydispersity |
| Classification | [Da] | [Da] | index |
| Virgin PA6 | 18,809 | 50,170 | 2.67 |
| Composite | 19,348 | 51,855 | 2.68 |
| material | | | |
| PA6 recovered | 19,084 | 52,856 | 2.77 |
| by adding | | | |
| 10 w/v % of | | | |
| composite | | | |
| material | | | |
| PA6 recovered | 20,168 | 83,105 | 2.63 |
| by adding | | | |
| 20 w/v % of | | | |
| composite | | | |
| material | | | |

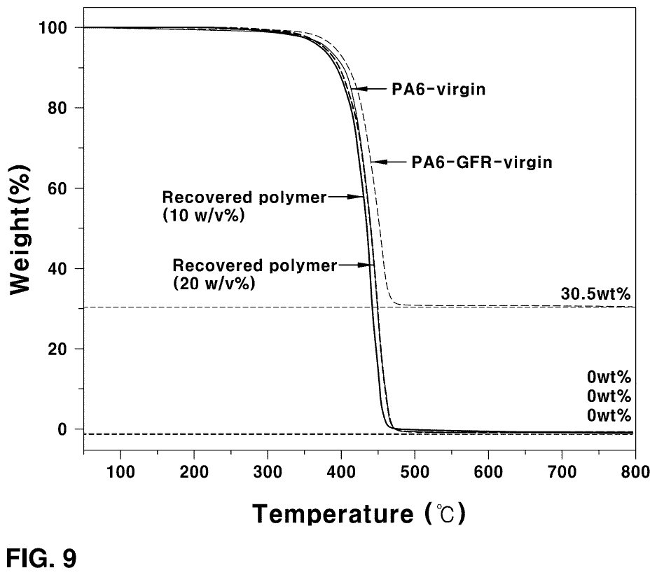

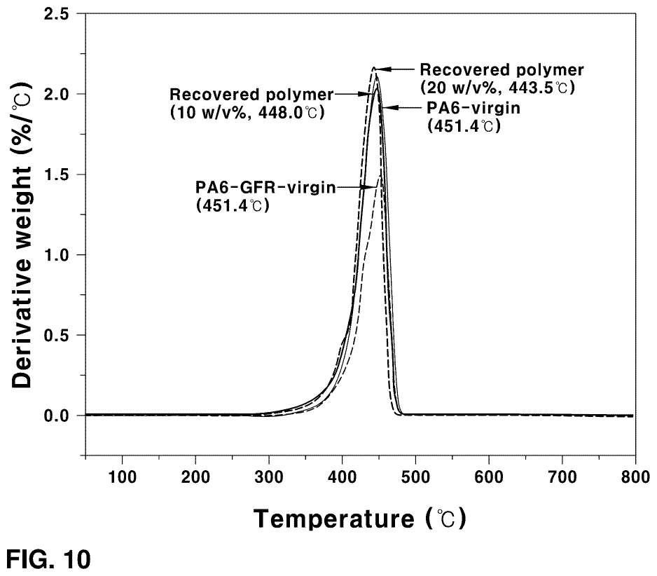

FIG. 9 shows results of thermogravimetric analysis (TGA) of Polyamide 6 recovered in Test Example 9. FIG. 10 shows results of derivative thermogravimetric analysis (DTG) of Polyamide 6 recovered in Test Example 9.

Based on all the results, it can be concluded that there was no difference in the properties of Polyamide 6 before and after recovery.

### Test Example 10

A solution was obtained by adding a composite material including 31.5 wt % of glass fiber and 68.5 wt % of Polyamide 66 to formic acid and dissolving Polyamide 66 in formic acid. The content of the composite material was adjusted to about 10 w/v % and 20 w/v %. The concentration of formic acid was 85 wt %, and Polyamide 66 was dissolved at 25° C. with stirring at about 300 rpm for 1 hour.

An intermediate material was obtained by filtering the glass fiber from the solution.

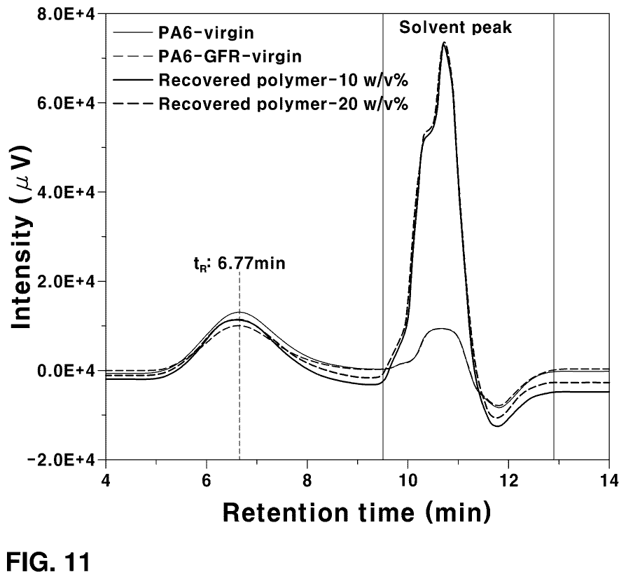

Methanol was added as an antisolvent to the intermediate material to precipitate Polyamide 66, and then the precipitated Polyamide 66 was recovered. The recovered Polyamide 66 was dried at about 70° C. for about 24 hours. FIG. 11 shows results of high-performance liquid chromatography of Polyamide 66 recovered in Test Example 10. The molecular weight and polydispersity index (PDI) of Polyamide 66 were measured, and the results thereof are shown in Table 8 below.

TABLE 8

| | Number average | Weight average | |
|---|---|---|---|
| | molecular weight | molecular weight | Polydispersity |
| Classification | [Da] | [Da] | index |
| Virgin PA66 | 21,748 | 56,913 | 2.62 |
| Composite | 24,451 | 57,719 | 2.36 |
| material | | | |
| PA66 recovered | 21,815 | 58,911 | 2.70 |
| by adding | | | |
| 10 w/v % of | | | |
| composite | | | |
| material | | | |
| PA66 recovered | 22,088 | 59,295 | 2.68 |
| by adding | | | |
| 20 w/v % of | | | |
| composite | | | |
| material | | | |

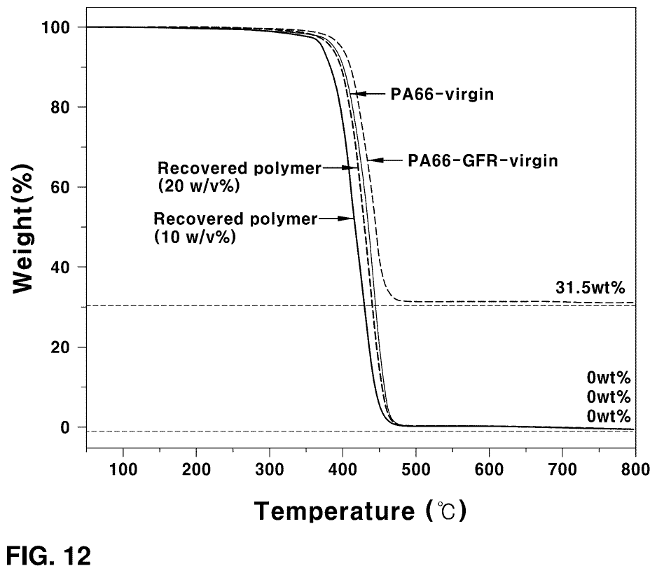

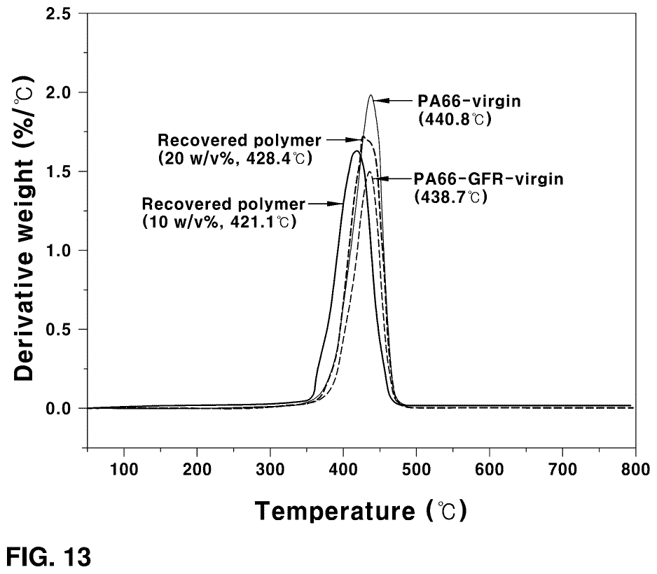

FIG. 12 shows results of thermogravimetric analysis (TGA) of Polyamide 66 recovered in Test Example 10. FIG. 13 shows results of derivative thermogravimetric analysis (DTG) of Polyamide 66 recovered in Test Example 10.

Based on all the results, it can be concluded that there was no difference in the properties of Polyamide 66 before and after recovery.

As is apparent from the foregoing, a method of recycling a reinforced resin having high recovery efficiency of polyamide is provided.

According to various aspects, a method of recycling a reinforced resin capable of recovering polyamide at room temperature under atmospheric pressure is provided.

Various aspects are not limited to the foregoing. It should be understood that the effects of the present disclosure include all effects that can be inferred from the description of the present disclosure.

Test examples and examples of the present disclosure have been described in detail above, the scope of the present disclosure is not limited to the aforementioned test examples and examples, and various modifications and improvements made by those having ordinary skill in the art using the basic concept of the present disclosure defined in the following claims are also within the scope of the present disclosure.

What is claimed is:

1. A method of recycling a reinforced resin, the method comprising:
obtaining a solution by adding a composite material including a polyamide and a reinforcing agent to a solvent and dissolving the polyamide in the solvent;
obtaining an intermediate material by filtering the reinforcing agent from the solution;
precipitating the polyamide by adding an antisolvent to the intermediate material; and
recovering the precipitated polyamide.

2. The method of claim 1, wherein the polyamide comprises one or more of Polyamide 6 (PA6) and Polyamide 66 (PA66).

3. The method of claim 1, wherein the reinforcing agent comprises glass fiber.

4. The method of claim 1, wherein the composite material comprises a range of 60 wt % to 80 wt % of the polyamide and a range of 20 wt % to 40 wt % of the reinforcing agent.

5. The method of claim 1, wherein the solvent comprises one or more of formic acid, benzyl alcohol, dimethyl sulfoxide (DMSO) and acetic acid.

6. The method of claim 1, wherein the solvent comprises formic acid, and obtaining the solution comprises dissolving the polyamide in the solvent in a range of 20° C. to 25° C.

7. The method of claim 6, wherein a concentration of the formic acid is at least 85 wt %.

8. The method of claim 1, wherein the solvent comprises benzyl alcohol, and obtaining the solution comprises dissolving the polyamide in the solvent in a range of 150° C. to 170° C.

9. The method of claim 1, wherein the solvent comprises dimethyl sulfoxide, and obtaining the solution comprises dissolving the polyamide in the solvent in a range of 115° C. to 135° C.

10. The method of claim 1, wherein the solvent comprises acetic acid, and obtaining the solution comprises dissolving the polyamide in the solvent in a range of 110° C. to 130° C.

11. The method of claim 1, wherein the composite material is added to the solvent so that a content of the composite material is in a range of 10 w/v % to 20 w/v %.

12. The method of claim 1, wherein obtaining the solution comprises dissolving the polyamide in the solvent for at least 1 hour.

13. The method of claim 1, wherein the antisolvent comprises methanol, ethanol, propanol, isopropanol, butanol, pentanol, hexanol, or any combinations thereof.

14. The method of claim 1, wherein precipitating the polyamide comprises adding the antisolvent to change a solubility of the polyamide of the intermediate material.

15. The method of claim 1, wherein a recovery efficiency of polyamide is at least 90%.
